(19) United States
(12) Patent Application Publication
(10) Pub. No.: US 2026/0051726 A1
(43) Pub. Date: Feb. 19, 2026

(54) BUS MODULE AND CONNECTOR ASSEMBLY

(71) Applicant: BIZLINK INTERNATIONAL CORP., New Taipei City (TW)

(72) Inventors: Zengshi LAO, New Taipei City (TW); Haoran ZOU, New Taipei City (TW)

(21) Appl. No.: 18/804,476

(22) Filed: Aug. 14, 2024

(51) Int. Cl. H02G 5/02; H01R 31/06; H02B 1/21; H02G 5/10

(52) U.S. Cl. CPC H02G 5/025; H01R 31/06; H02B 1/21; H02G 5/10

(57) ABSTRACT

A bus module includes an upper bus plate, a lower bus plate, an electrical connector, and two adapter plates. The upper bus plate includes a first horizontal plate. The lower bus plate includes a second horizontal plate parallel to the first horizontal plate. The electrical connector includes a positive terminal and a negative terminal. Each of the adapter plates includes a vertical plate, a fixing plate, and an arched arm connected between the vertical plate and the fixing plate. The vertical plate and the fixing plate of one of the adapter plates are respectively connected to the positive terminal and the first horizontal plate. The vertical plate and the fixing plate of another of the adapter plates are respectively connected to the negative terminal and the second horizontal plate.

### BACKGROUND

### TECHNICAL FIELD

The present disclosure relates to a bus module and a connector assembly.

### DESCRIPTION OF RELATED ART

With the development of the information industry and the Internet, services provided through the Internet are increasingly appearing in various applications. Today, data centers are widely used in big data processing and application services in cloud computing and information technology (IT).

A prior art TW201913281A provides a bus bar assembly for electrically connecting a server in a server rack to an external bus bar, so that power can be supplied from the external bus bar to the internal components of the server via the bus bar assembly. However, during the transportation of the server rack, the bus bar assembly is easily damaged due to collision.

Accordingly, how to provide a bus module and a connector assembly that can efficiently solve the aforementioned problem becomes an important issue to be solved by those in the industry.

### SUMMARY

An aspect of the disclosure is to provide a bus module and a connector assembly that can efficiently solve the aforementioned problem.

According to an embodiment of the disclosure, a bus module includes an upper bus plate, a liquid cooling tube, a lower bus plate, an electrical connector, and two adapter plates. The upper bus plate includes a first horizontal plate. The liquid cooling tube is in contact with the first horizontal plate. The lower bus plate includes a second horizontal plate parallel to the first horizontal plate. The electrical connector includes a positive terminal and a negative terminal. Each of the adapter plates includes a vertical plate, a fixing plate, an arched arm connected between the vertical plate and the fixing plate, and a bent portion connected between the arched arm and the vertical plate. A width of the fixing plate is less than a width of the bent portion. The vertical plate and the fixing plate of one of the adapter plates are respectively connected to the positive terminal and the first horizontal plate. The vertical plate and the fixing plate of another of the adapter plates are respectively connected to the negative terminal and the second horizontal plate.

In an embodiment of the disclosure, the width of the bent portion is less than about 1.3 times the width of the fixing plate.

In an embodiment of the disclosure, the width of the bent portion is greater than about 1.1 times the width of the fixing plate.

In an embodiment of the disclosure, the width of the bent portion is less than a width of the vertical plate.

In an embodiment of the disclosure, the width of the bent portion is less than about 0.4 times the width of the vertical plate.

In an embodiment of the disclosure, the width of the bent portion is greater than about 0.25 times the width of the vertical plate.

In an embodiment of the disclosure, a width of the arched arm increases from the fixing plate toward the vertical plate.

In an embodiment of the disclosure, the arched arm includes a first part and a second part connected to each other and respectively adjacent to the fixing plate and the vertical plate. A width of the first part increases from the fixing plate to the second part.

In an embodiment of the disclosure, the second part of the arched arm has a uniform width greater than the width of the first part.

In an embodiment of the disclosure, the arched arm has a highest point relative to the fixing plate. The first part and the second part of the arched arm are connected to each other substantially at the highest point.

In an embodiment of the disclosure, the arched arm includes a first part and a second part connected to each other. The first part includes a first concave arc portion connected to the fixing plate and a first convex arc portion connected to the first concave arc portion. The second part includes a second convex arc portion connected to the first part and a second concave arc portion connected to the second concave arc portion.

In an embodiment of the disclosure, a radius of curvature of the first concave arc portion is less than a radius of curvature of the first convex arc portion.

In an embodiment of the disclosure, a radius of curvature of the second concave arc portion is less than a radius of curvature of the second convex arc portion.

In an embodiment of the disclosure, a surface of the first horizontal plate away from the second horizontal plate has a recess. The liquid cooling tube is embedded in the recess.

According to an embodiment of the disclosure, a connector assembly includes an electrical connector and two adapter plates. The electrical connector includes a positive terminal and a negative terminal. Each of the adapter plates includes a vertical plate, a fixing plate, and an arched arm connected between the vertical plate and the fixing plate. The vertical plate of one of the adapter plates is connected to the positive terminal. The vertical plate of another of the adapter plates is connected to the negative terminal. Each of the adapter plates further includes a bent portion connected between the arched arm and the vertical plate. A width of the bent portion is less than a width of the vertical plate.

In an embodiment of the disclosure, each of the adapter plates further includes a bent portion connected between the arched arm and the vertical plate. A width of the fixing plate is less than the width of the bent portion.

In an embodiment of the disclosure, a width of the arched arm increases from the fixing plate toward the vertical plate.

In an embodiment of the disclosure, the arched arm includes a first part and a second part connected to each other and respectively adjacent to the fixing plate and the vertical plate. A width of the first part increases from the fixing plate to the second part.

In an embodiment of the disclosure, the arched arm includes a first part and a second part connected to each other. The first part includes a first concave arc portion connected to the fixing plate and a first convex arc portion connected to the first concave arc portion. The second part includes a second convex arc portion connected to the first part and a second concave arc portion connected to the second concave arc portion.

Accordingly, in the bus module of the present disclosure, since the adapter plate connected between the upper bus plate and the electrical connector and the adapter plate connected between the lower bus plate and the electrical connector each have an arched arm, the bus module will not be easily damaged by collision. Specifically, the adapter plate provided with the arched arm has better elastic deformation ability, so it can effectively absorb the impact force of collision.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a bus module according to an embodiment of the present disclosure;

FIG. 2 is a perspective view of one of connector assemblies of the bus module in FIG. 1 with a housing of an electrical connector removed;

FIG. 3 is a top view of an adapter plate in FIG. 2; and

FIG. 4 is a partial side view of the adapter plate in FIG. 3.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

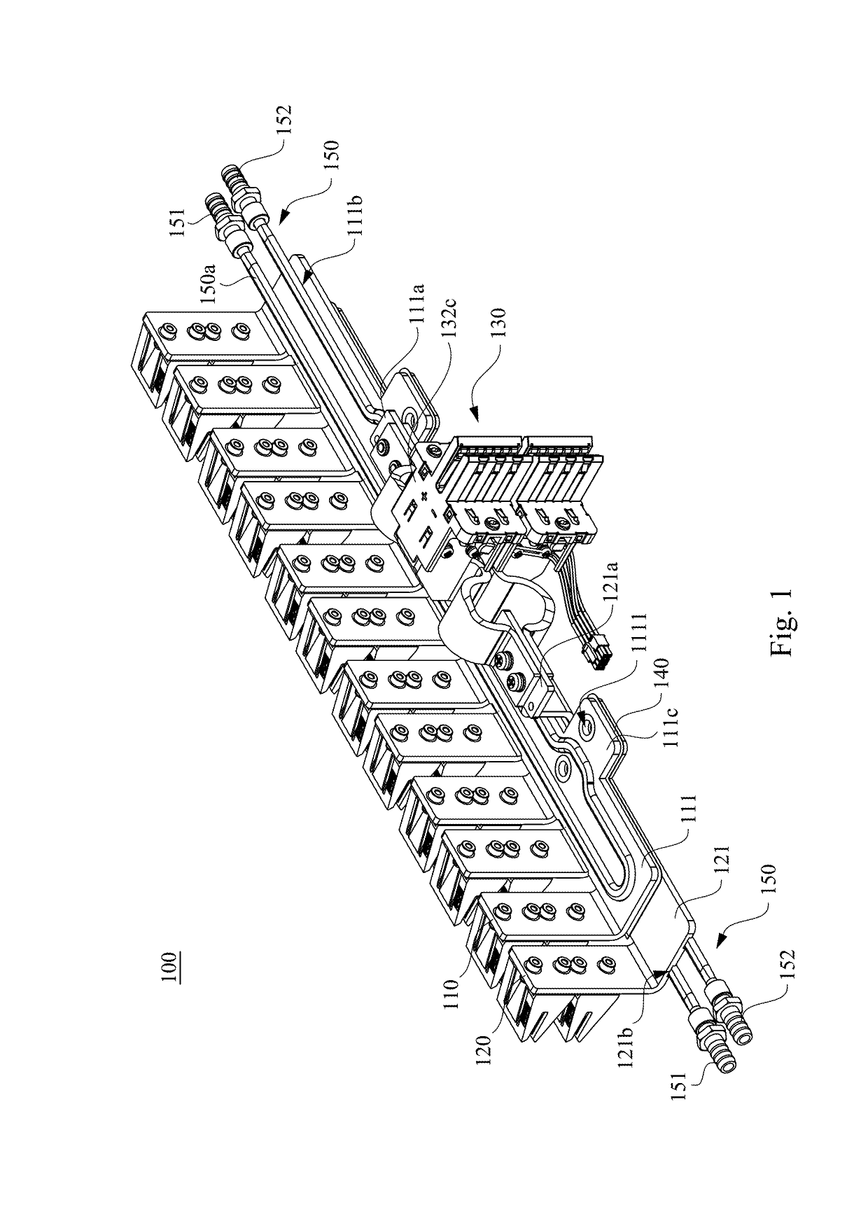

Reference is made to FIG. 1. FIG. 1 is a perspective view of a bus module 100 according to an embodiment of the present disclosure. For example, the bus module 100 may be applied to electrically connect a server in a server rack (not shown), so as to supply power to the server. As shown in FIG. 1, the bus module 100 includes an upper bus plate 110, a lower bus plate 120, and two connector assemblies 130. The upper bus plate 110 is stacked above the lower bus plate 120, and an insulating layer is sandwiched between the upper bus plate 110 and the lower bus plate 120 to electrically insulating the upper bus plate 110 and the lower bus plate 120. Specifically, the upper bus plate 110 includes a first horizontal plate 111. The lower bus plate 120 includes a second horizontal plate 121. The second horizontal plate 121 is parallel to the first horizontal plate 111. The insulating layer is sandwiched between the first horizontal plate 111 and the second horizontal plate 121.

As shown in FIG. 1, each of the two connector assemblies 130 is electrically connected to the upper bus plate 110 and the lower bus plate 120. Specifically, the two connector assemblies 130 are arranged one above the other. The first horizontal plate 111 includes a first coupling portion 111a extending to a side of the two connector assemblies 130. The second horizontal plate 121 includes a second coupling portion 121a extending to another side of the two connector assemblies 130. The upper one of the connector assemblies 130 is connected to an upper surface of the first coupling portion 111a and an upper surface of the second coupling portion 121a, and the lower one of the connector assemblies 130 is connected to a lower surface of the first coupling portion 111a and a lower surface of the second coupling portion 121a.

In other embodiments, the bus module 100 may include only one of the connector assemblies 130.

As shown in FIG. 1, the bus module 100 further includes two liquid cooling tubes 150. Each of the two liquid cooling tubes 150 has a liquid inlet connector 151 and a liquid outlet connector 152. At least a portion of each of the two liquid cooling tubes 150 is embedded in the first horizontal plate 111 and the second horizontal plate 121 respectively. Specifically, a surface of the first horizontal plate 111 away from the second horizontal plate 121 has a recess 111b, and one of the liquid cooling tubes 150 is embedded in the recess 111b. Similarly, a surface of the second horizontal plate 121 away from the first horizontal plate 111 has a recess 121b, and the other of the liquid cooling tubes 150 is embedded in the recess 121b.

In some embodiments, as shown in FIG. 1, both of the top surface and the bottom surface of the liquid cooling tubes 150 are flat surfaces.

Moreover, a height of the liquid cooling tubes 150 is between about 100% to 200% of a depth of the recess 111b and the recess 121b, which means a majority of the liquid cooling tubes 150 may embedded in the recesses 111b, 121b so as to control the height thereof.

As shown in FIG. 1, each of the first horizontal plate 111 and the second horizontal plate 121 further includes a pair of protruding portions 111c overlapped to each other respectively. The protruding portions 111c horizontally extend from an edge of the main portion of first horizontal plate 111 and an edge of the main portion of the second horizontal plate 121 respectively.

As shown in FIG. 1, the first horizontal plate 111 and the second horizontal plate 121 each have two pairs of fixing holes 1111. Each of the fixing holes 1111 of the first horizontal plate 111 is aligned with a corresponding fixing hole 1111 of and the second horizontal plate 121, and each of the fixing holes 1111 is a through hole. One of the holes in one of the pairs of fixing holes 1111 is located on the protruding portion 111c, and the other is on the main portion right next to it. The liquid cooling tube 150 embedded in the first horizontal plate 111 turns and extends through an area between both pairs of fixing holes 1111.

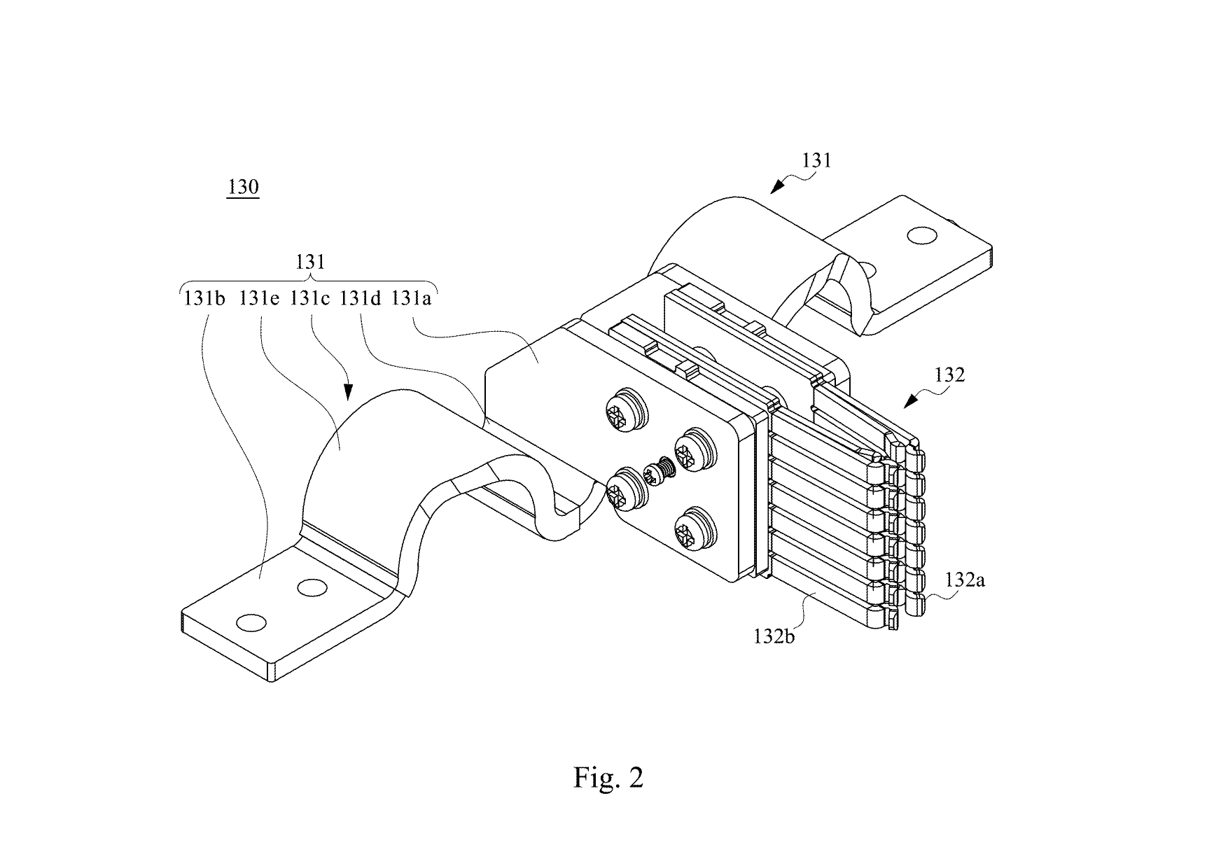

Reference is made to FIG. 2. FIG. 2 is a perspective view of one of the connector assemblies 130 of the bus module 100 in FIG. 1 with a housing 132c of an electrical connector 132 removed. As shown in FIG. 2, in the present embodiment, the connector assembly 130 includes the electrical connector 132 and two adapter plates 131 (i.e., the two connector assemblies 130 in FIG. 1 include four adapter plates 131). The electrical connector 132 includes a plurality of positive terminals 132a and a plurality of negative terminals 132b. The two adapter plates 131 extend away from each other and are symmetric relative to the electrical connector 132. Each of the adapter plates 131 includes a vertical plate 131a, a fixing plate 131b, and an arched arm 131c connected between the vertical plate 131a and the fixing plate 131b. The vertical plate 131a and the fixing plate 131b of one of the adapter plates 131 (i.e., the right one of the adapter plate 131 in FIG. 2) are respectively connected to the positive terminals 132a and the first coupling portion 111a of the first horizontal plate 111. The vertical plate 131a and the fixing plate 131b of another of the adapter plates 131 (i.e., the left one of the adapter plate 131 in FIG. 2) are respectively connected to the negative terminals 132b and the second coupling portion 121a of the second horizontal plate 121.

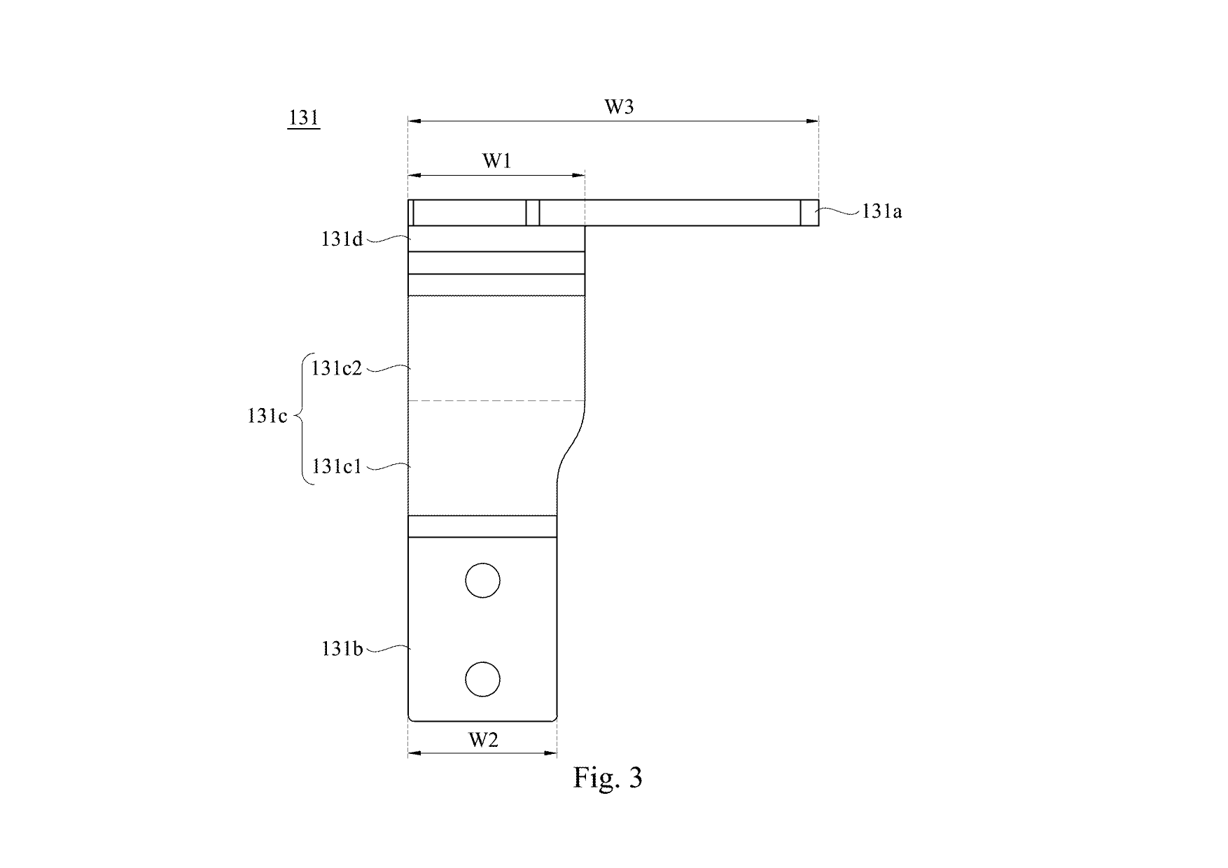

Reference is made to FIG. 3. FIG. 3 is a top view of an adapter plate 131 in FIG. 2. As shown in FIG. 3, the adapter plate 131 further includes a bent portion 131d connected between the arched arm 131c and the vertical plate 131a. A width W2 of the fixing plate 131b is less than a width W1 of the bent portion 131d. The bent portion 131d with the larger width W1 helps in power transfer of the adapter plate 131. Specifically, the vertical plate 131a, the bent portion 131d, the arched arm 131c, and the fixing plate 131b are sequentially arranged in one lateral direction, and the width W1 of the bent portion 131d and width W2 of the fixing plate 131b are measured in another lateral direction perpendicular to the one lateral direction.

In some embodiments, the width W1 of the bent portion 131d is less than about 1.3 times the width W2 of the fixing plate 131b. In some embodiments, the width W1 of the bent portion 131d is greater than about 1.1 times the width W2 of the fixing plate 131b. In a specific example, the width W1 of the bent portion 131d is about 28.6 mm, and the width W2 of the fixing plate 131b is about 24.1 mm.

As shown in FIG. 3, the width W1 of the bent portion 131d is less than a width W3 of the vertical plate 131a.

In some embodiments, the width W1 of the bent portion 131d is less than about 0.4 times the width W3 of the vertical plate 131a. In some embodiments, the width W1 of the bent portion 131d is greater than about 0.25 times the width W3 of the vertical plate 131a. In a specific example, the width W1 of the bent portion 131d is about 28.6 mm, and the width W3 of the vertical plate 131a is about 66.5 mm.

As shown in FIG. 3, a width of the arched arm 131c increases from the fixing plate 131b toward the bent portion 131d. That is, the width of the arched arm 131c increases from the width W2 to the width W1. Specifically, the arched arm 131c includes a first part 131c1 and a second part 131c2 connected to each other and respectively connected to the fixing plate 131b and the bent portion 131d. A width of the first part 131c1 increases from the fixing plate 131b to the second part 131c2. The second part 131c2 has a uniform width greater than the width of the first part 131c1. As shown in FIG. 3, the uniform width of the second part 131c2 is equal to the width W1 of the bent portion 131d. An end of the first part 131c1 connected to the fixing plate 131b has a width equal to the width W2 of the fixing plate 131b. In other words, the width of the first part 131c1 increases from the width W2 to the width W1 from the fixing plate 131b toward the second part 131c2. As shown in FIG. 3, a junction between the first part 131c1 and the second part 131c2 is substantially in the middle of the arched arm 131c.

As shown in FIG. 3, an edge of the first part 131c1 at one side (i.e., the left side) of the arched arm 131c is straight, and an edge of the first part 131c1 at another side (i.e., the right side) of the arched arm 131c is curved.

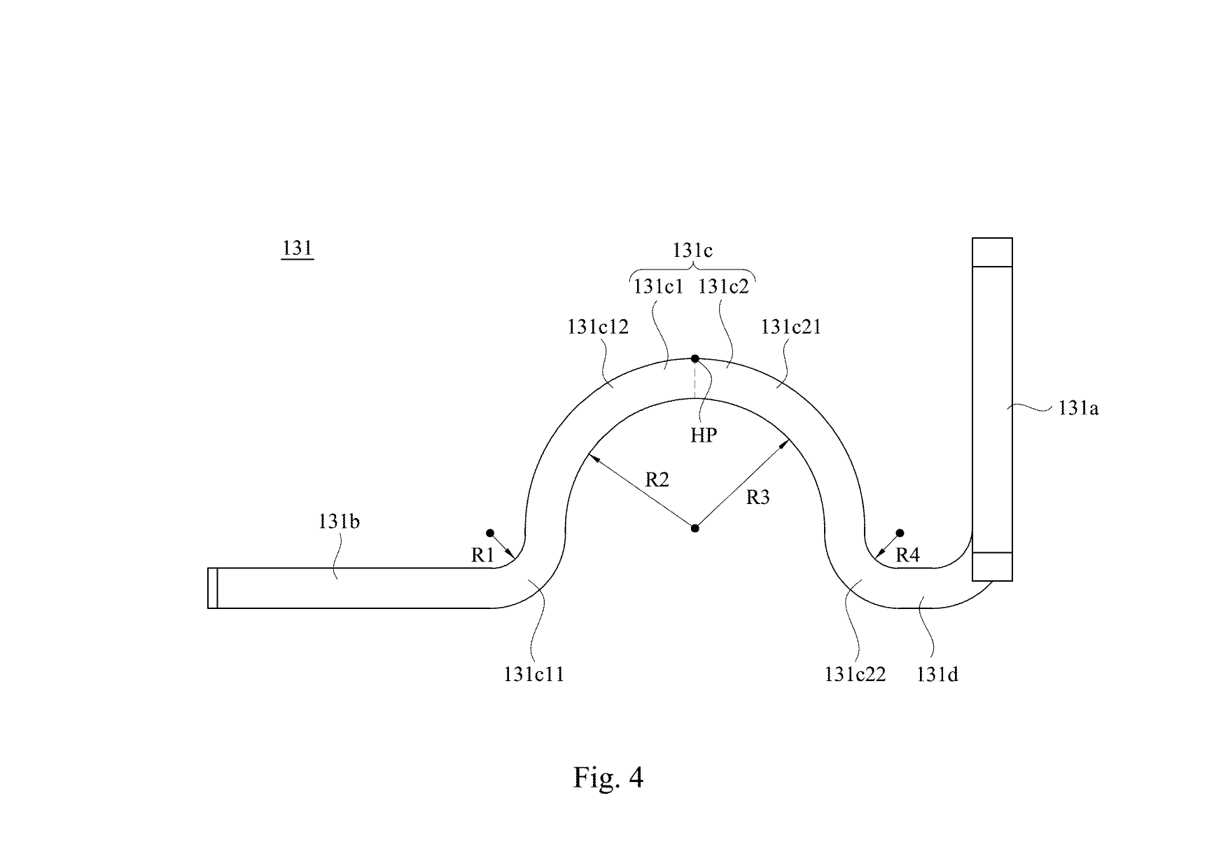

Reference is made to FIG. 4. FIG. 4 is a partial side view of the adapter plate 131 in FIG. 3. As shown in FIG. 4, the arched arm 131 has a highest point HP relative to the fixing plate 131b. The first part 131c1 and the second part 131c2 of the arched arm 131c are connected to each other substantially at the highest point HP.

As shown in FIG. 4, the first part 131c1 of the arched arm 131c includes a first concave arc portion 131c11 connected to the fixing plate 131b and a first convex arc portion 131c12 connected to the first concave arc portion 131c11. The second part 131c2 of the arched arm 131c includes a second convex arc portion 131c21 connected to the first part 131c1 and a second concave arc portion 131c22 connected to the second convex arc portion 131c21. That is, the first convex arc portion 131c12, the first concave arc portion 131c11, the second convex arc portion 131c21, and the second concave arc portion 131c22 are alternately bent back and forth from the fixing plate 131b to the bent portion 131d.

As shown in FIG. 4, the first concave arc portion 131c11 has a radius R1 of curvature, the first convex arc portion 131c12 has a radius R2 of curvature, the second convex arc portion 131c21 has a radius R3 of curvature, and the second concave arc portion 131c22 has a radius R4 of curvature. In this way, the first convex arc portion 131c12, the first concave arc portion 131c11, the second convex arc portion 131c21, and the second concave arc portion 131c22 are connected smoothly and sequentially.

As shown in FIG. 4, the radius R1 of curvature of the first concave arc portion 131c11 is less than the radius R2 of curvature of the first convex arc portion 131c12. The radius R4 of curvature of the second concave arc portion 131c22 is less than the radius R3 of curvature of the second convex arc portion 131c21.

In some embodiments, the radius R2 of curvature of the first convex arc portion 131c12 is more than three times the radius R1 of curvature of the first concave arc portion 131c11. In some embodiments, the radius R3 of curvature of the second convex arc portion 131c21 is more than three times the radius R4 of curvature of the second concave arc portion 131c22. In a specific example, the radius R2 of curvature of the first convex arc portion 131c12 and the radius R3 of curvature of the second convex arc portion 131c21 are about 13.6 mm, and the radius R1 of curvature of the first concave arc portion 131c11 and the radius R4 of curvature of the second concave arc portion 131c22 are in a range from about 3.5 mm to about 4.0 mm.

In addition, the drawings in FIGS. 1 to 4 are drawn true to scale. In order to keep the disclosure concise, the proportions of each component are not listed one by one, but the proportions and positions of each component should be regarded as part of the content of this disclosure.

According to the foregoing recitations of the embodiments of the disclosure, it can be seen that in the bus module of the present disclosure, since the adapter plate connected between the upper bus plate and the electrical connector and the adapter plate connected between the lower bus plate and the electrical connector each have an arched arm, the bus module will not be easily damaged by collision. Specifically, the adapter plate provided with the arched arm has better elastic deformation ability, so it can effectively absorb the impact force of collision.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A bus module, comprising:
an upper bus plate comprising a first horizontal plate;
a liquid cooling tube in contact with the first horizontal plate;
a lower bus plate comprising a second horizontal plate parallel to the first horizontal plate;
an electrical connector comprising a positive terminal and a negative terminal; and
two adapter plates each comprising a vertical plate, a fixing plate, an arched arm connected between the vertical plate and the fixing plate, and a bent portion connected between the arched arm and the vertical plate, wherein a width of the fixing plate is less than a width of the bent portion,
wherein the vertical plate and the fixing plate of one of the adapter plates are respectively connected to the positive terminal and the first horizontal plate, and the vertical plate and the fixing plate of another of the adapter plates are respectively connected to the negative terminal and the second horizontal plate.

2. The bus module of claim 1, wherein the width of the bent portion is less than about 1.3 times the width of the fixing plate.

3. The bus module of claim 1, wherein the width of the bent portion is greater than about 1.1 times the width of the fixing plate.

4. The bus module of claim 1, wherein the width of the bent portion is less than a width of the vertical plate.

5. The bus module of claim 4, wherein the width of the bent portion is less than about 0.4 times the width of the vertical plate.

6. The bus module of claim 4, wherein the width of the bent portion is greater than about 0.25 times the width of the vertical plate.

7. The bus module of claim 1, wherein a width of the arched arm increases from the fixing plate toward the vertical plate.

8. The bus module of claim 1, wherein the arched arm comprises a first part and a second part connected to each other and respectively adjacent to the fixing plate and the vertical plate, and a width of the first part increases from the fixing plate to the second part.

9. The bus module of claim 8, wherein the second part of the arched arm has a uniform width greater than the width of the first part.

10. The bus module of claim 8, wherein the arched arm has a highest point relative to the fixing plate, and the first part and the second part of the arched arm are connected to each other substantially at the highest point.

11. The bus module of claim 1, wherein the arched arm comprises a first part and a second part connected to each other, the first part comprises a first concave arc portion connected to the fixing plate and a first convex arc portion connected to the first concave arc portion, and the second part comprises a second convex arc portion connected to the first part and a second concave arc portion connected to the second concave arc portion.

12. The bus module of claim 11, wherein a radius of curvature of the first concave arc portion is less than a radius of curvature of the first convex arc portion.

13. The bus module of claim 11, wherein a radius of curvature of the second concave arc portion is less than a radius of curvature of the second convex arc portion.

14. The bus module of claim 1, wherein a surface of the first horizontal plate away from the second horizontal plate has a recess, and the liquid cooling tube is embedded in the recess.

15. A connector assembly, comprising:
an electrical connector comprising a positive terminal and a negative terminal; and
two adapter plates each comprising a vertical plate, a fixing plate, and an arched arm connected between the vertical plate and the fixing plate,
wherein the vertical plate of one of the adapter plates is connected to the positive terminal, and the vertical plate of another of the adapter plates is connected to the negative terminal,
wherein each of the adapter plates further comprises a bent portion connected between the arched arm and the vertical plate, and a width of the bent portion is less than a width of the vertical plate.

16. The connector assembly of claim 15, wherein a width of the fixing plate is less than the width of the bent portion.

17. The connector assembly of claim 15, wherein a width of the arched arm increases from the fixing plate toward the vertical plate.

18. The connector assembly of claim 15, wherein the arched arm comprises a first part and a second part connected to each other and respectively adjacent to the fixing plate and the vertical plate, and a width of the first part increases from the fixing plate to the second part.

19. The connector assembly of claim 15, wherein the arched arm comprises a first part and a second part connected to each other, the first part comprises a first concave arc portion connected to the fixing plate and a first convex arc portion connected to the first concave arc portion, and the second part comprises a second convex arc portion connected to the first part and a second concave arc portion connected to the second concave arc portion.
